(19) United States
(12) Patent Application Publication
(10) Pub. No.: US 2009/0098446 A1
(43) Pub. Date: Apr. 16, 2009

(54) SECONDARY BATTERY

(76) Inventors: Yukihiro OKADA, Osaka (JP); Kiyomi Kozuki, Osaka (JP); Hideaki Fujita, Osaka (JP)

Correspondence Address: MCDERMOTT WILL & EMERY LLP, 600 13TH STREET, NW, WASHINGTON, DC, 20005-3096, US

(21) Appl. No.: 12/237,157

(22) Filed: Sep. 24, 2008

(30) Foreign Application Priority Data
Sep. 25, 2007 (JP) 2007-247044

(51) Int. Cl. H01M 6/10

(52) U.S. Cl. 429/94

(57) ABSTRACT

The secondary battery of this invention includes: an electrode assembly comprising a first electrode and a second electrode which are wound or laminated with only a heat-resistant porous insulating layer interposed between the first electrode and the second electrode; and a first current collector plate electrically connected to the first electrode. The first electrode includes a first electrode mixture layer formed on a first electrode core member. The second electrode includes a second electrode mixture layer formed on a second electrode core member. An end of the first electrode protrudes from an end of the second electrode and an end of the porous insulating layer at an end face of the electrode assembly. The protruding end of the first electrode has a part where the first electrode core member is exposed. The part where the first electrode core member is exposed is welded to the first current collector plate. The end of the porous insulating layer protrudes from an end of the first electrode mixture layer and an end of the second electrode mixture layer. The distance between the first current collector plate and the end of the porous insulating layer on the first current collector plate side is 3 mm or less.

### FIELD OF THE INVENTION

The invention relates to a secondary battery having a low-resistant current-collecting structure which is suited for a large current discharge.

### BACKGROUND OF THE INVENTION

Secondary batteries, such as non-aqueous electrolyte secondary batteries, nickel-metal hydride storage batteries, and nickel cadmium secondary batteries, are used as the driving power source for various devices. Secondary batteries are used in various applications ranging from commercial appliances such as cellular phones to electric vehicles and power tools. Among them, non-aqueous electrolyte secondary batteries represented by lithium ion secondary batteries are receiving attention since they are small and light-weight and have high energy density. Recently, developments of secondary batteries having higher energy density and higher power have become active.

To heighten the power of batteries, it has been proposed, for example, to employ a tabless structure as the current-collecting structure of a battery in order to reduce the current-collecting resistance of the electrode and the internal resistance of the battery. The tabless structure is described below. A strip-like electrode comprises an electrode core member and an electrode mixture layer formed on the electrode core member. One end of such an electrode in the width direction is provided with a part where the active material layer is not formed and the electrode core member is exposed. An electrode assembly is fabricated so that the part where the electrode core member is exposed protrudes at one end face of the electrode assembly. A current collector plate is connected to the end of the exposed part.

With respect to such batteries having the tabless structure, various examinations have been made. For example, Japanese Laid-Open Patent Publication No. Hei 10-83833 proposes providing a battery cover with a positive electrode terminal and a negative electrode terminal, and connecting an electrode lead, which is attached to a current collector plate disposed on the lower part of an electrode assembly, to the electrode terminal by passing it through the hollow of the mandrel of the electrode assembly. Japanese Laid-Open Patent Publication No. 2000-285900 proposes modifying the shape of a current collector plate so that the current collector plate can be connected to the part where the electrode core member is exposed by crimping the current collector plate onto the part where an electrode core member is exposed. Japanese Laid-Open Patent Publication No. 2005-235695 proposes the use of an electrode having a heat-resistant layer on the surface.

However, in Japanese Laid-Open Patent Publication No. Hei 10-83833, in a production process of the battery, the current collector plate is welded to the part where the electrode core member is exposed. Due to heat generated by the welding, the polyethylene or polypropylene separator may partially shrink or melt, thereby causing a micro short-circuit between the positive electrode and the negative electrode and resulting in low battery reliability. One method to reduce the impact of heat on a separator upon welding of a current collector plate to an electrode can be to secure a sufficient distance between the current collector plate and the separator. However, if a sufficient distance is secured, the electrode mixture layer (electrode area) becomes small and the battery energy density decreases.

In the structure of Japanese Laid-Open Patent Publication No. 2000-285900, in which the current collector plate is crimped onto the part where the electrode core member is exposed for connection, there is no need to weld the current collector plate to the part where the electrode core member is exposed. Hence, the separator is not affected by heat generated by welding. However, in this structure, the part where the electrode core member is exposed needs to be sufficient, so the battery energy density decreases in the same manner as Japanese Laid-Open Patent Publication No. Hei 10-83833.

In Japanese Laid-Open Patent Publication No. 2005-235695, which uses a polyethylene film as the separator, when the current collector plate is welded to the part where the electrode core member is exposed, the separator may shrink or melt due to the impact of heat generated by the welding, in the same manner as in Japanese Laid-Open Patent Publication No. Hei 10-83833. At this time, the heat-resistant layer serves to some extent to prevent an internal short-circuit due to a contact between the positive electrode and the negative electrode. However, the heat-resistant layer may partially separate from the polyethylene film due to shrinkage of the separator, thereby causing a micro internal short-circuit.

In order to solve such problems associated with conventional art, it is therefore an object of the invention to provide a secondary battery having a tabless structure and being capable of providing high energy density and improved reliability as well as high power.

### BRIEF SUMMARY OF THE INVENTION

The secondary battery of the invention includes: an electrode assembly including a first electrode and a second electrode which are wound or laminated with only a heat-resistant porous insulating layer interposed between the first electrode and the second electrode; and a first current collector plate electrically connected to the first electrode. The first electrode includes a first electrode core member and a first electrode mixture layer formed on the first electrode core member. The second electrode includes a second electrode core member and a second electrode mixture layer formed on the second electrode core member. An end of the first electrode protrudes from an end of the second electrode and an end of the porous insulating layer at an end face of the electrode assembly. The protruding end of the first electrode has a part where the first electrode core member is exposed. The part where the first electrode core member is exposed is welded to the first current collector plate. The end of the porous insulating layer protrudes from an end of the first electrode mixture layer and an end of the second electrode mixture layer. The distance between the first current collector plate and the end of the porous insulating layer on the first current collector plate side is 3 mm or less.

Preferably, it further includes a second current collector plate electrically connected to the second electrode, wherein an end of the second electrode protrudes from an end of the first electrode and an end of the porous insulating layer at another end face of the electrode assembly, the protruding end of the second electrode has a part where the second electrode core member is exposed, and the part where the second electrode core member is exposed is welded to the second current collector plate.

The distance between the second current collector plate and the end of the porous insulating layer on the second current collector plate side is preferably 3 mm or less.

The porous insulating layer preferably includes ceramic particles.

The porous insulating layer preferably includes ceramic particles and a binder.

The porous insulating layer is preferably formed so as to cover at least one of the first electrode mixture layer and the second electrode mixture layer.

The secondary battery is preferably a non-aqueous electrolyte secondary battery.

The part where the first electrode core member is exposed is preferably connected to the first current collector plate by arc welding.

The part where the second electrode core member is exposed is preferably connected to the second current collector plate by arc welding.

According to the invention, it is possible to provide a secondary battery having a tabless structure and being capable of providing high energy density and improved reliability as well as high power.

Even when the welding of the current collector plate to the part where the electrode core member is exposed involves the generation of heat, the heat-resistant porous insulating layer disposed between the positive electrode and the negative electrode is not affected by the heat. That is, in the welding process, the porous insulating layer does not shrink or melt unlike the polyolefin film conventionally used as the separator. Since only the porous insulating layer is disposed between the positive electrode and the negative electrode, an internal short-circuit due to shrinkage or melting of a separator can be prevented in a reliable manner.

Since the porous insulating layer has excellent heat resistance, the distance between the current collector plate and the porous insulating layer can be reduced. That is, it is possible to make the area of the porous insulating layer facing the positive and negative electrodes larger than that of a conventional separator, and enlarge the electrode mixture layers (electrode area).

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view of a cylindrical non-aqueous electrolyte secondary battery which is one embodiment of a secondary battery of the invention;

FIG. 2 is a cross-sectional view of the main part of FIG. 1;

FIG. 3 is a front view of a positive electrode used in FIG. 1;

FIG. 4 is a front view of a negative electrode used in FIG. 1;

FIG. 5 is a cross-sectional view of the main part of batteries of Comparative Examples 1 and 2; and

FIG. 6 is a cross-sectional view of the main part of a battery of Comparative Example 3.

### DETAILED DESCRIPTION OF THE INVENTION

The invention relates to a secondary battery having a so-called tabless structure. The secondary battery of the invention includes: an electrode assembly including a strip-like first electrode and a strip-like second electrode which are wound or laminated with a separator interposed between the first electrode and the second electrode; and a first current collector plate electrically connected to the first electrode. The first electrode includes a first electrode core member and a first electrode mixture layer formed on the first electrode core member. The second electrode includes a second electrode core member and a second electrode mixture layer formed on the second electrode core member. An end of the first electrode protrudes from an end of the second electrode and an end of the porous insulating layer at an end face of the electrode assembly. The protruding end of the first electrode has a part where the first electrode core member is exposed. The part where the first electrode core member is exposed is welded to the first current collector plate. The end of the porous insulating layer protrudes from an end of the first electrode mixture layer and an end of the second electrode mixture layer. The invention is characterized in that the separator is composed only of a heat-resistant porous insulating layer that is not affected by heat generated by the welding of the part where the first electrode core member is exposed to the first current collector plate, and that the distance between the first current collector plate and the end of the porous insulating layer on the first current collector plate side is 3 mm or less.

The end of the porous insulating layer on the first current collector plate side may be in contact with the first current collector plate. The first electrode is one of the positive electrode and the negative electrode, and the second electrode is the other of the positive electrode and the negative electrode. The first electrode core member is one of the positive electrode core member and the negative electrode core member, and the second electrode core member is the other of the positive electrode core member and the negative electrode core member. The first electrode mixture layer is one of the positive electrode mixture layer and the negative electrode mixture layer, and the second electrode mixture layer is the other of the positive electrode mixture layer and the negative electrode mixture layer. The first current collector plate is one of the positive electrode current collector plate and the negative electrode current collector plate. The electrode assembly may be composed of first electrodes and second electrodes that are laminated.

According to the invention, it is possible to provide a secondary battery having a tabless structure and being capable of providing high energy density and improved reliability as well as high power.

Even when the welding of the current collector plate to the part where the electrode core member is exposed involves the generation of heat, the heat-resistant porous insulating layer disposed between the positive electrode and the negative electrode is not affected by the heat, and does not shrink or melt unlike the polyethylene film or polypropylene film conventionally used as the separator. Also, since only the porous insulating layer is disposed between the positive electrode and the negative electrode, an internal short-circuit due to the shrinkage or melting of a separator can be prevented in a reliable manner. Therefore, the reliability of the battery improves.

Since the porous insulating layer has excellent heat resistance, the distance between the current collector plate and the porous insulating layer can be reduced. It is thus possible to make the electrode mixture layers (electrode area) large. Also, the part where the electrode core member is exposed can be minimized. It is therefore possible to obtain a high energy density battery.

If the distance between the first current collector plate and the end of the porous insulating layer on the first current collector plate side exceeds 3 mm, the electrode mixture layers become small, so that the energy density of the battery may become low.

It is preferable that both the positive electrode and the negative electrode have a tabless structure, since the resultant battery can provide higher power. That is, it is preferable that the secondary battery further include a second current collector plate electrically connected to the second electrode, wherein an end of the second electrode protrudes from an end of the first electrode and an end of the porous insulating layer at another end face of the electrode assembly, the protruding end of the second electrode has a part where the second electrode core member is exposed, and the part where the second electrode core member is exposed is welded to the second current collector plate.

The distance between the second current collector plate and the end of the porous insulating layer on the second current collector plate side is preferably 3 mm or less, since the energy density of the battery can be further heightened.

The porous insulating layer can be disposed between the positive electrode and the negative electrode in such a manner that it protrudes from at least the end(s) of the positive electrode mixture layer and the negative electrode mixture layer. The porous insulating layer can protrude from the end(s) of the electrode mixture layers, for example, by 0.5 to 5 mm.

When the areas of the positive electrode (positive electrode mixture layer) and the negative electrode (negative electrode mixture layer) are different, the porous insulating layer can protrude from the end(s) of the electrode mixture layer of the electrode whose electrode mixture layer has a larger area. The porous insulating layer can protrude from the end(s) of the electrode mixture layer of the positive electrode or the negative electrode, whichever has a larger electrode mixture layer, for example, by 0.5 to 5 mm.

It is preferable to integrate the porous insulating layer with at least one of the positive electrode and the negative electrode before fabricating the electrode assembly. For example, it is preferable to form the porous insulating layer on at least one of the positive electrode and the negative electrode.

The porous insulating layer is preferably formed so as to cover the electrode mixture layer of at least one of the positive electrode and the negative electrode. More preferably, the porous insulating layer covers the electrode mixture layer of the electrode having a larger electrode area (electrode mixture layer area) to form an electrode complex.

As described above, when the porous insulating layer is integrated with the electrode, there is no need to additionally dispose a separator comprising a porous insulating layer between the positive electrode and the negative electrode when laminating or winding them. Hence, problems such as winding deviation do not occur.

Also, it is more preferable that the porous insulating layer cover the whole surface of the electrode mixture layer, since the positive electrode and the negative electrode can be insulated from each other in a reliable manner, and the porous insulating layer can be easily formed between the positive electrode and the negative electrode so as to protrude from the ends of the positive and negative electrode mixture layers. At this time, the porous insulating layer may cover the end of the part where the electrode core member is exposed on the electrode mixture layer side, together with the end of the electrode mixture layer on the electrode core member exposed part side.

The current collector plate is preferably connected to the part where the electrode core member is exposed by arc welding. In arc welding, heat concentration during welding is suppressed, and it is thus possible to prevent formation of a hole in a welded area and occurrence of a problem such as an OCV defect.

Examples of the secondary battery of the invention include nickel-cadmium storage batteries, nickel-metal hydride storage batteries, and non-aqueous electrolyte secondary batteries. In non-aqueous electrolyte secondary batteries, which use a non-aqueous electrolyte having a lower conductivity than an aqueous electrolyte, there is a need to use a very thin separator. Such a separator is susceptible to the impact of heat upon welding, and an internal short-circuit is likely to occur. Therefore, the invention is remarkably effective for non-aqueous electrolyte secondary batteries.

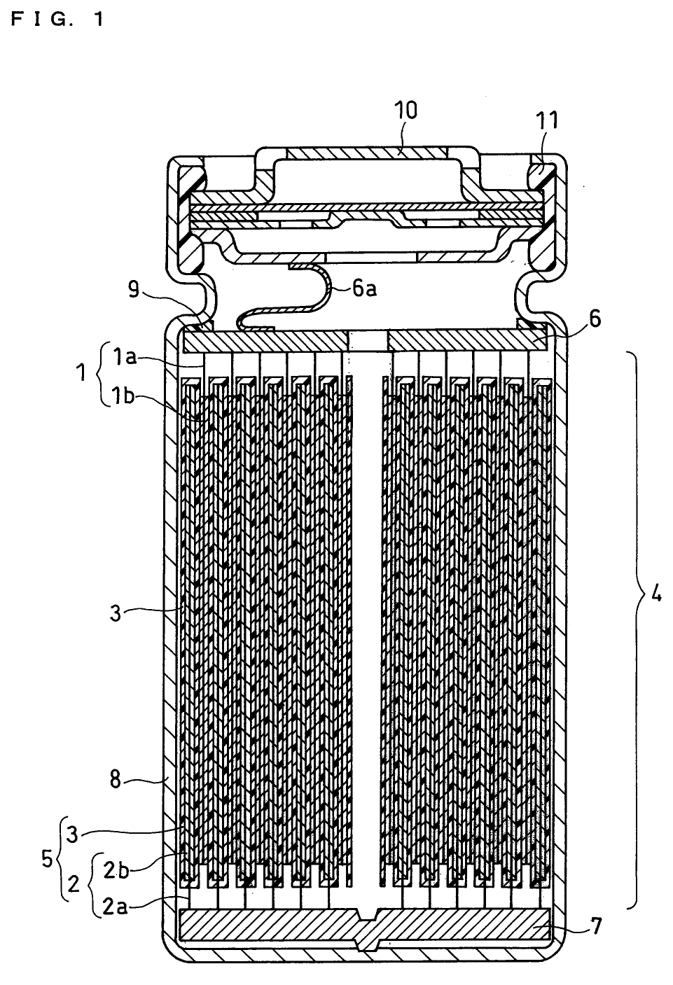

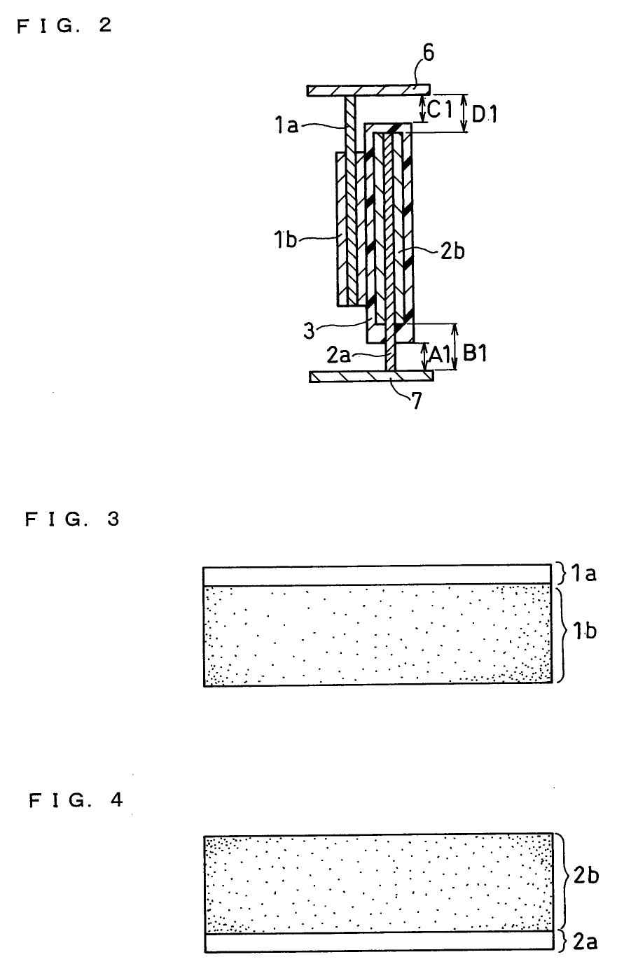

With reference to drawings, an embodiment of the secondary battery of the invention is described. FIG. 1 is a schematic longitudinal sectional view of a cylindrical non-aqueous electrolyte secondary battery which is one embodiment of the secondary battery of the invention. FIG. 2 is a longitudinal cross-sectional view of the main part of the battery of FIG. 1. FIG. 3 is a front view of a positive electrode used in the battery of FIG. 1. FIG. 4 is a front view of a negative electrode used in the battery of FIG. 1.

As illustrated in FIG. 1, a battery container 8 contains an electrode assembly 4 comprising a strip-like positive electrode 1 and a strip-like negative electrode 2 which are wound with a porous insulating layer 3 interposed therebetween. For example, a resin holding member shaped like a rod may be disposed in the hollow in the mandrel of the electrode assembly 4. The positive electrode 1 has a positive electrode core member and positive electrode mixture layers 1b formed on both faces of the positive electrode core member. The negative electrode 2 has a negative electrode core member and negative electrode mixture layers 2b formed on both faces of the negative electrode core member.

As illustrated in FIG. 3, the positive electrode 1 has a part where the positive electrode mixture layer 1b is not formed and the positive electrode core member is exposed (hereinafter “positive electrode core member exposed part 1a”) which extends linearly along the longitudinal direction at one end of the positive electrode core member in the width direction. As illustrated in FIG. 4, the negative electrode 2 has a part where the negative electrode mixture layer 2b is not formed and the negative electrode core member is exposed (hereinafter “negative electrode core member exposed part 2a”) which extends linearly along the longitudinal direction at one end of the negative electrode core member in the width direction.

The positive electrode 1 is disposed so that at an end face (upper end face) of the electrode assembly 4, the end (upper end) of the positive electrode 1 protrudes from the end of the negative electrode 2 and the end of the porous insulating layer 3, and that the positive electrode core member exposed part 1a is positioned at the protruding end of the positive electrode 1. The negative electrode 2 is disposed so that at another end face (lower end face) of the electrode assembly 4, the end (lower end) of the negative electrode 2 protrudes from the end of the positive electrode 1 and the end of the porous insulating layer 3, and that the negative electrode core member exposed part 2a is positioned at the protruding end of the negative electrode 2.

The positive electrode core member exposed part 1a is welded to a disc-like positive electrode current collector plate 6. The negative electrode core member exposed part 2a is welded to a disc-like negative electrode current collector plate 7. The welding may be performed by an ordinary method.

The method for welding the electrode core member exposed part to the current collector plate can be a welding method such as arc welding, laser welding, or electron beam welding. Specifically, with one face of the current collector plate in contact with the electrode core member exposed part, energy is applied from the other face of the current collector plate by arc discharge etc. Among the aforementioned welding methods, arc welding is preferred. Arc welding permits easy and highly reliable welding without damaging the electrode core member. According to arc welding, since heat concentration during welding is suppressed, it is possible to prevent formation of a hole in a welded area and suppress occurrence of a problem such as an OCV defect. Examples of arc welding include TIG (tungsten inert gas) welding, MIG welding, MAG welding, and carbon dioxide arc welding, and TIG welding is particularly preferable. TIG welding is particularly effective when the current collector plate is composed of, for example, copper or aluminum. TIG welding allows only the current collector plate to melt easily, and permits easy and highly reliable welding without damaging the electrode core member. In the case of, for example, lithium ion secondary batteries, the thickness of the electrode core member is, for example, approximately 10 to 30 μm. Thus, TIG welding is preferable also in terms of suppressing problems such as a short-circuit due to buckling of the electrode core member. The conditions of TIG welding are, for example, current values 150 A to 250 A and welding time 5 msec to 20 msec. Upon welding, the temperature of the part of the current collector plate joined to the electrode core member is, for example, approximately 1100° C. The porous insulating layer 3 can be composed of a material that is not affected by such heat due to welding and does not melt or shrink.

An electrode structure comprising the positive electrode current collector plate 6, the negative electrode current collector plate 7, and the electrode assembly 4 is housed in the battery container 8. The negative electrode current collector plate 7 is connected to the bottom of the battery container 8. The upper part of the positive electrode current collector plate 6 is provided with a ring-like insulator plate 9 in order to provide insulation from the battery container 8. A positive electrode lead 6a attached to the positive electrode current collector plate 6 is passed through the opening of the insulator plate 9 and is connected to the lower part of a battery cover having a seal plate 10. A non-aqueous electrolyte is injected into the battery container 8. The open edge of the battery container 8 is crimped onto the circumference of the battery cover with a gasket 11 interposed therebetween, so as to seal the battery container 8.

The positive electrode core member can be, for example, a metal foil having a thickness of 10 to 30 μm. An example of such metal foil is aluminum foil. Also, the positive electrode core member may be perforated metal.

The thickness of the positive electrode current collector plate 6 is, for example, 0.3 to 2 mm. The positive electrode current collector plate 6 can be, for example, an aluminum plate.

The positive electrode mixture layer includes, for example, a positive electrode active material, a positive electrode conductive material, and a positive electrode binder. Examples of the positive electrode active material include lithium containing oxides and modified materials thereof. Specifically, lithium cobaltate, modified lithium cobaltate, lithium nickelate, modified lithium nickelate, lithium manganate, and modified lithium manganate are used. Examples of such modified materials are modified materials containing aluminum or manganese. It is also possible to use modified materials containing cobalt, nickel, or manganese. Examples of the positive electrode conductive material are graphite, carbon black, and metal. Examples of the positive electrode binder are polyvinylidene fluoride (PVDF) and polytetrafluoroethylene (PTFE).

The negative electrode core member can be, for example, a metal foil having a thickness of 8 to 20 μm. An example of such metal foil is copper foil. Also, the negative electrode core member can be perforated metal.

The negative electrode current collector plate 7 can be, for example, a nickel plate, copper plate, or nickel-plated copper plate. The thickness of the negative electrode current collector plate 7 is, for example, 0.3 to 2 mm.

The negative electrode mixture layer includes, for example, a negative electrode active material, a negative electrode conductive material, and a negative electrode binder. Examples of the negative electrode active material include carbon materials, aluminum, aluminum alloys, metal oxides such as tin oxides, and metal nitrides. Examples of carbon materials are natural graphite and artificial graphite. Examples of the negative electrode conductive material are graphite, carbon black, and metal. Examples of the negative electrode binder are styrene-butadiene copolymer rubber (SBR) and carboxymethyl cellulose (CMC).

In this embodiment, by covering the whole surface of the negative electrode mixture layers 2b formed on the negative electrode core member with the porous insulating layer 3, the negative electrode 2 is integrated with the porous insulating layer 3 to form a negative electrode complex 5. The porous insulating layer 3 covering the end of the negative electrode mixture layer 2b on the negative electrode core member exposed part 2a side also covers the end of the negative electrode core member exposed part 2a on the negative electrode mixture layer 2b side.

The electrode assembly 4 can be fabricated by winding the positive electrode 1 and the negative electrode complex 5. When the positive electrode 1 and the negative electrode 2 are wound to fabricate the electrode assembly 4, there is no need to separately dispose the porous insulating layer 3 between the positive electrode 1 and the negative electrode 2. Thus, upon the winding, it is possible to prevent winding deviation.

The negative electrode complex 5 can be obtained, for example, by applying a slurry containing raw materials such as ceramics and a binder to a predetermined area of the negative electrode by a gravure roll method and drying it to form a porous insulating layer on the negative electrode.

Also, in this embodiment, in the plane where the positive electrode 1 and the negative electrode 2 face each other, the negative electrode mixture layer 2b has a larger area than the positive electrode mixture layer 1b. That is, the end of the negative electrode mixture layer 2b facing the positive electrode current collector plate 6 and the end of the negative electrode mixture layer 2b facing the negative electrode current collector plate 7 protrude from the end of the positive electrode mixture layer 1b facing the positive electrode current collector plate 6 and the end of the positive electrode mixture layer 1b facing the negative electrode current collector plate 7, respectively. In the case of this embodiment, it is sufficient to consider the distance between the positive and negative electrode current collectors and the negative electrode complex.

As illustrated in FIG. 2, the distance (A1 in FIG. 2) between the negative electrode current collector plate 7 and the end of the porous insulating layer 3 on the negative electrode current collector plate 7 side is 3 mm or less. In this case, a battery having high power, high energy density, and high reliability can be obtained. If the distance A1 is greater than 3 mm, the positive and negative electrode mixture layers become small, so that the energy density of the battery may become low.

The thickness ((B1-A1) in FIG. 2) of the porous insulating layer 3 formed on the lower end face of the negative electrode mixture layer 2b facing the negative electrode current collector plate 7 is preferably 0.5 to 5 mm. If the thickness (B1-A1) is less than 0.5 mm, it is difficult to secure sufficient insulation between the negative electrode mixture layer and the positive electrode mixture layer. If the thickness (B1-A1) is greater than 5 mm, the positive and negative electrode mixture layers become small, so that the energy density of the battery may become low.

The porous insulating layer 3 formed on the lower end face of the negative electrode mixture layer 2b is formed on the negative electrode core member exposed part 2a. Hence, it can be retained on the negative electrode 2 in a more reliable manner and its thickness can be increased compared with the porous insulating layer 3 that is formed on the negative electrode mixture layer 2b facing the positive electrode mixture layer 1b and the upper end face of the negative electrode 2. If the thickness (B1-A1) is less than 1 mm, the distance A1 is preferably 1 mm or more in terms of the impact of heat on the negative electrode mixture layers 2b upon the welding of the negative electrode 2 to the negative electrode current collector plate 7.

The distance (C1 in FIG. 2) between the positive electrode current collector plate 6 and the end of the porous insulating layer 3 on the positive electrode current collector plate 6 side is 3 mm or less. In this case, a battery having high power, high energy density, and high reliability can be obtained. If the distance C1 is greater than 3 mm, the positive and negative electrode mixture layers become small, so that the energy density of the battery may become low.

The thickness ((D1-C1) in FIG. 2) of the porous insulating layer 3 formed on the upper end face of the negative electrode 2 is preferably 10 μm to 3 mm. If the thickness (D1-C1) is less than 10 μm, it is difficult to ensure that the porous insulating layer provides insulation between the positive electrode current collector plate 6 and the upper end face of the negative electrode 2 facing the positive electrode current collector plate 6. If the thickness (D1-C1) is greater than 3 mm, the positive and negative electrode mixture layers become small, so that the energy density of the battery may become low.

If the thickness (D1-C1) is less than 1 mm, the distance C1 is preferably 1 mm or more in terms of the insulation between the positive electrode current collector plate 6 and the negative electrode 2, and the impact of heat on the negative electrode mixture layers 2b upon the welding of the positive electrode 1 to the positive electrode current collector plate 6.

In order to secure insulation and achieve higher power and higher energy density, the thickness of the porous insulating layer 3 (the part facing the positive and negative electrodes) is preferably 10 to 30 μm. More preferably, the thickness of the porous insulating layer 3 (the part facing the positive and negative electrodes) is preferably 15 to 25 μm.

The porous insulating layer 3 is formed of, for example, an imide-type compound or ceramics. These materials have good insulation, high melting points, and excellent stability. The ceramics can be an oxide, nitride, or carbide. They may be used singly or in combination of two or more of them. Among them, an oxide is preferable since it is, for example, readily available. Examples of usable oxides are alumina (aluminum oxide), titania (titanium oxide), zirconia (zirconium oxide), magnesia (magnesium oxide), zinc oxide, and silica (silicon oxide). Among them, alumina is preferable, and a-alumina is particularly preferable. α-alumina is chemically stable, and high purity one is particularly stable. Also, α-alumina does not cause a side reaction with electrolyte in oxidation reduction potential which adversely affects battery performance.

The porous insulating layer 3 preferably includes ceramics particles. The mean particle size of the ceramics particles (primary particles) is, for example, 0.05 to 1 μm. The ceramics particles may include spherical secondary particles that is formed by agglomeration of primary particles by van der Waals force.

Also, the ceramics particles desirably include polycrystalline particles that are formed of the nuclei of monocrystals jointed together. While the polycrystalline particles may be spherical or may partially have protrusions, they are preferably shaped like dendrites, coral, or clusters. Ceramics particles including polycrystalline particles can be obtained, for example, by baking a ceramics precursor to obtain ceramics and mechanically crushing the ceramics. The ceramics have a structure in which the grown nuclei of monocrystals are three-dimensionally jointed together. By mechanically crushing such ceramics to a suitable extent, ceramics particles including polycrystalline particles can be obtained. While all the ceramics particles are preferably formed of polycrystalline particles, the ceramics particles can contain, for example, less than 30% by weight of polycrystalline particles. The ceramics particles may contain particles other than polycrystalline particles, for example, spherical or substantially spherical primary particles, or agglomerated particles thereof.

The porous insulating layer 3 is preferably composed of such ceramics particles and a binder. The binder can be, for example, fluorocarbon resin. Examples of usable fluorocarbon resin are polyvinylidene fluoride (PVDF), polytetrafluoroethylene (PTFE), and tetrafluoroethylene-hexafluoropropylene copolymer (FEP). The binder may be a polyacrylic acid derivative or a polyacrylonitrile derivative. Each of the polyacrylic acid derivative and the polyacrylonitrile derivative is preferably composed of at least one of an acrylic acid unit and an acrylonitrile unit and at least one selected from the group consisting of a methyl acrylate unit, an ethyl acrylate unit, a methyl methacrylate unit, and an ethyl methacrylate unit. Also, the binder may be polyethylene or styrene-butadiene rubber. They may be used singly or in combination of two or more of them. Among them, a polymer containing an acrylonitrile unit, i.e., a polyacrylonitrile derivative, is preferable. When the binder is such material, the porous insulating layer has good flexibility, so the porous insulating layer is unlikely to become cracked or separated.

The porosity of the porous insulating layer 3 is preferably 30 to 80%, more preferably 40 to 80%, and most preferably 50 to 70%. When the porosity of the porous insulating layer is 30% or more, the charge/discharge characteristics at a large current (hereinafter “high-rate characteristics”) and the charge/discharge characteristics in a low temperature environment (hereinafter “low temperature characteristics”) become good. If the porosity of the porous insulating layer is 40% or more, the high-rate characteristics and low temperature characteristics become excellent. If the porosity of the porous insulating layer is greater than 80%, the mechanical strength of the porous insulating layer decreases.

The electrode assembly 4 includes a non-aqueous electrolyte. The non-aqueous electrolyte can be, for example, a liquid non-aqueous electrolyte composed of a non-aqueous solvent and a lithium salt dissolved in the non-aqueous solvent, or a gelled electrolyte prepared by adding a polymer material to such a non-aqueous electrolyte. The lithium salt can be, for example, lithium hexafluorophosphate (LiPF₆) or lithium tetrafluoroborate (LiBF₄). Examples of the non-aqueous solvent include cyclic carbonates such as ethylene carbonate and propylene carbonate and chain carbonates such as dimethyl carbonate, diethyl carbonate, and ethyl methyl carbonate, and they may be used singly or in combination of two or more of them. Also, the non-aqueous electrolyte may further include an additive such as vinylene carbonate, cyclohexyl benzene, or diphenyl ether.

Examples of the invention are hereinafter described in detail, but the invention is not limited to these Examples.

### EXAMPLE 1

### (1) Preparation of Positive Electrode

A positive electrode mixture slurry was prepared by kneading 3 kg of lithium cobaltate serving as a positive electrode active material, 90 g of acetylene black of Denki Kagaku Kogyo K.K. serving as a positive electrode conductive material, 100 g of Teflon 230J (aqueous dispersion containing 60% by weight of PTFE) of DU PONT-MITSUI FLUOROCHEMICALS COMPANY LTD. serving as a positive electrode binder, and a suitable amount of water with a planetary mixer. This positive electrode mixture was applied onto both faces of a positive electrode core member made of aluminum foil (thickness 15 μm, width 53 mm) and dried, so that a positive electrode mixture layer 1b was formed on each side of the positive electrode core member. At this time, a 3-mm wide positive electrode core member exposed part 1a was provided at one end of the positive electrode core member along the longitudinal direction, and the width of the positive electrode mixture layer 1b was set to 50 mm. In this way, a positive electrode 1 illustrated in FIG. 3 was obtained. The positive electrode 1 was rolled so that the thickness of the positive electrode 1 was made 100 μm.

### (2) Preparation of Negative Electrode

A negative electrode mixture slurry was prepared by kneading 3 kg of artificial graphite serving as a negative electrode active material, 75 g of BM-400B (aqueous dispersion containing 40% by weight of styrene-butadiene copolymer (rubber particles)) of Zeon Corporation serving as a negative electrode binder, 30 g of carboxymethyl cellulose (CMC) serving as a thickener, and a suitable amount of water. This negative electrode mixture was applied onto both faces of a negative electrode core member made of copper foil (thickness 10 μm, width 57 mm) and dried, so that a negative electrode mixture layer 2b was formed on each side of the negative electrode core member. At this time, a 3-mm wide negative electrode core member exposed part 2a was provided at one end of the negative electrode core member along the longitudinal direction, and the width of the negative electrode mixture layer 2b was set to 54 mm. In this way, a negative electrode illustrated in FIG. 4 was obtained. The negative electrode 2 was rolled so that the thickness of the negative electrode 2 was made 110 μm.

### (3) Formation of Porous Insulating Layer

A slurry was prepared by kneading 1000 g of an alumina powder with a median diameter of 0.3 μm, 375 g of BM-720H (NMP solution containing 8% by weight of a rubbery polymer including an acrylonitrile unit) of Zeon Corporation, and a suitable amount of an NMP solvent with a planetary mixer. This slurry was applied onto the negative electrode mixture layer of the negative electrode obtained in the above manner by a gravure roll method at a speed of 0.5 m/min, and dried with hot air of 120° C. which was supplied at an air flow rate of 0.5 m/sec. In this way, a 20-μm thick porous insulating layer 3 was formed on each face of the negative electrode (the face of the negative electrode mixture layer facing the positive electrode mixture layer).

The positions of the gravure roll and the negative electrode 2 were adjusted so that the slurry could be applied onto the end of the negative electrode core member exposed part 2a on the negative electrode mixture layer 2b side. The slurry was applied at a width of 2 mm onto the end of the negative electrode core member exposed part 2a on the negative electrode mixture layer 2b side so as to cover the lower end face of the negative electrode mixture layer 2b, in order to form the porous insulating layer 3. That is, the porous insulating layer 3 having a thickness ((B1-A1) in FIG. 2) of 2 mm was formed on the lower end faces of the negative electrode mixture layers 2b facing the negative electrode current collector plate 7.

Further, the slurry was applied onto the upper end face of the negative electrode 2 facing the positive electrode current collector plate 6 to form the porous insulating layer 3 having a thickness ((D1-C1) in FIG. 2) of 100 μm. In this way, the whole surface of the negative electrode mixture layers 2b was covered with the porous insulating layer 3 to obtain a negative electrode complex 5. The porous insulating layer 3 was not formed, and thus the negative electrode core member was exposed, on the other area of the negative electrode core member exposed part 2a than the end of the negative electrode core member exposed part 2a on the negative electrode mixture layer 2b side.

### (4) Preparation of Non-Aqueous Electrolyte

A non-aqueous electrolyte was prepared by dissolving LiPF₆ at a concentration of 1 mol/L in a solvent mixture containing ethylene carbonate (EC), dimethyl carbonate (DMC), and ethyl methyl carbonate (EMC) in a volume ratio of 2:3:3. Further, 2 parts by weight of vinylene carbonate (VC) was added to 100 parts by weight of the non-aqueous electrolyte.

### (5) Production of Battery

The positive electrode 1 and the negative electrode complex 5 obtained in the above manner were cut to a length of 100 cm in the longitudinal direction. Using them, an electrode assembly 4 was produced. More specifically, to produce the cylindrical electrode assembly 4, the positive electrode 1 and the negative electrode complex 5 were wound such that the positive electrode core member exposed part 1a protruded at one end face of the electrode assembly 4 while the negative electrode core member exposed part 2a protruded at another end face of the electrode assembly 4. At this time, a 20-μm thick porous insulating layer was also disposed on the innermost side of the electrode assembly 4.

While the end of the positive electrode core member exposed part 1a was TIG welded to a positive electrode current collector plate 6, the end of the negative electrode core member exposed part 2a was TIG welded to a negative electrode current collector plate 7, in order to produce an electrode structure. At this time, the distance A1 between the negative electrode current collector plate 7 and the end of the porous insulating layer 3 on the negative electrode current collector plate 7 side was set to 1 mm. The distance C1 between the positive electrode current collector plate 6 and the end of the porous insulating layer 3 on the positive electrode current collector plate 6 side was set to 1 mm. The positive electrode current collector plate 6 was an aluminum disc (thickness 1 mm, diameter 14 mm). The negative electrode current collector plate 7 was a copper disc (thickness 1 mm, diameter 14 mm). The conditions of the TIG welding were current value 180 A and welding time 50 msec.

The electrode structure was inserted into a cylindrical battery container 8 (diameter 18 mm, height 65 mm) having a bottom and made of a nickel plated steel plate. The negative electrode current collector plate 7 was resistance welded to the inner bottom face of the battery container 8. One end of a positive electrode lead 6a was attached to the positive electrode current collector plate 6. A battery cover with a seal plate 10 serving as the positive electrode terminal was prepared. The other end of the positive electrode lead 6a was laser welded to the lower face of the battery cover. The non-aqueous electrolyte prepared in the above manner was injected into the battery container 8 at a reduced pressure. The open edge of the battery container 8 was crimped onto the circumference of the seal plate 10 with a resin gasket 11 therebetween, to seal the battery container 8. In this way, a non-aqueous electrolyte secondary battery (1) was produced.

### EXAMPLE 2

A positive electrode 1 was produced in the same manner as in Example 1, except that a positive electrode core member made of aluminum foil (thickness 15 μm width 51 mm) was used, that a 5-mm wide positive electrode core member exposed part 1a was provided at one end of the positive electrode core member in the longitudinal direction, and that the width of the positive electrode mixture layer 1b was set to 46 mm.

A negative electrode 2 was produced in the same manner as in Example 1, except that a negative electrode core member made of copper foil (thickness 10 μm, width 55 mm) was used, that a 5-mm wide negative electrode core member exposed part 2a was provided at one end of the negative electrode core member in the longitudinal direction, and that the width of the negative electrode mixture layer 2b was set to 50 mm.

The distance A1 between the negative electrode current collector plate 7 and the end of the porous insulating layer 3 on the negative electrode current collector plate 7 side was set to 3 mm. The distance C1 between the positive electrode current collector plate 6 and the end of the porous insulating layer 3 on the positive electrode current collector plate 6 side was set to 3 mm.

Except for the above, in the same manner as in Example 1, a battery (2) was produced.

### COMPARATIVE EXAMPLE 1

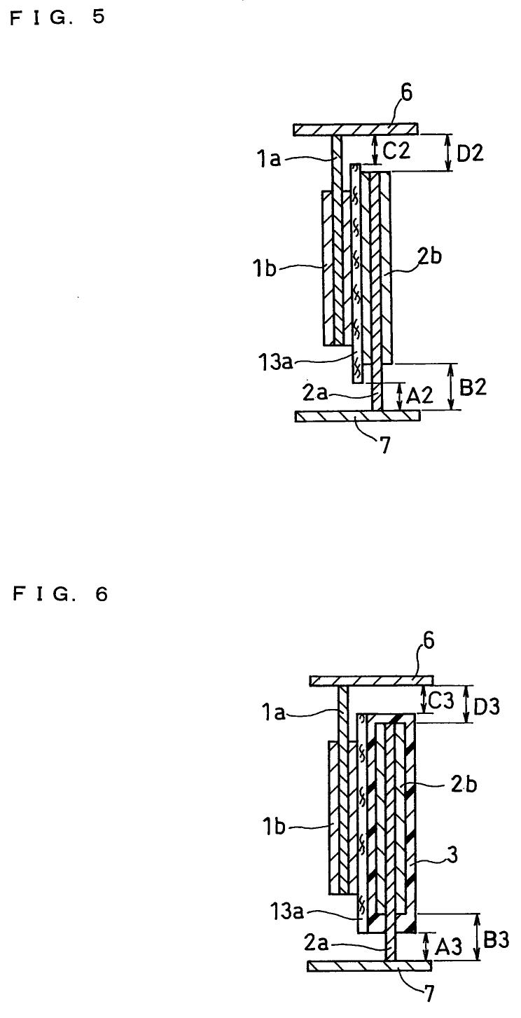

As illustrated in FIG. 5, instead of the porous insulating layer 3, a strip-like polyethylene film 13a (available from Asahi Kasei Chemicals Corporation, thickness 20 μm) was disposed as a separator between the positive electrode 1 and the negative electrode 2.

The distance A2 between the negative electrode current collector plate 7 and the end of the polyethylene film 13a on the negative electrode current collector plate 7 side was set to 1 mm. The length (B2-A2) of the part of the polyethylene film protruding from the lower end of the negative electrode mixture layer 2b was set to 2 mm. The distance C2 between the positive electrode current collector plate 6 and the end of the polyethylene film 13a on the positive electrode current collector plate 6 side was set to 1 mm. The length (D2-C2) of the part of the polyethylene film 13a protruding from the upper end of the negative electrode 2 was set to 100 μm.

Except for the above, in the same manner as in Example 1, a battery (3) was produced.

### COMPARATIVE EXAMPLE 2

A positive electrode was produced in the same manner as in Example 1, except that a positive electrode core member made of aluminum foil (thickness 15 μm, width 51 mm) was used, that a 7-mm wide positive electrode core member exposed part 1a was provided at one end of the positive electrode core member in the longitudinal direction, and that the width of the positive electrode mixture layer 1b was set to 44 mm.

A negative electrode was produced in the same manner as in Example 1, except that a copper foil having a thickness of 10 μm and a width of 53 mm was used, that a 5-mm wide negative electrode core member exposed part 2a was provided at one end of the negative electrode core member in the longitudinal direction, and that the width of the negative electrode mixture layer 2b was set to 48 mm.

The distance A2 between the negative electrode current collector plate 7 and the end of the polyethylene film 13a on the negative electrode current collector plate 7 side was set to 3 mm. The distance C2 between the positive electrode current collector plate 6 and the end of the polyethylene film 13a on the positive electrode current collector plate 6 side was set to 3 mm.

Except for the above, in the same manner as in Comparative Example 1, a battery (4) was produced.

### COMPARATIVE EXAMPLE 3

As illustrated in FIG. 6, the same positive electrode 1 as that of Example 1 and the same negative electrode complex 5 as that of Example 1 were laminated with the same polyethylene film 13a as that of Comparative Example 1 interposed between the positive electrode 1 and the negative electrode complex 5, to form an electrode assembly. At this time, the upper and lower ends of the polyethylene film 13a were aligned with the upper and lower ends of the negative electrode complex 5.

Specifically, the distance A3 between the negative electrode current collector plate 7 and the ends of the porous insulating layer 3 and the polyethylene film 13a on the negative electrode current collector plate 7 side was set to 1 mm. The length of the part of the polyethylene film 13a protruding from the lower end of the negative electrode mixture layer 2b and the thickness of the porous insulating layer 3 formed on the lower end face of the negative electrode mixture layer 2b facing the negative electrode current collector plate 7, i.e., the dimension of (B3-A3), were set to 2 mm. The distance C3 between the positive electrode current collector plate 6 and the ends of the porous insulating layer 3 and the polyethylene film 13a on the positive electrode current collector plate 6 side was set to 1 mm. The length of the part of the polyethylene film 13a protruding from the upper end of the negative electrode 2 and the thickness of the porous insulating layer 3 formed on the upper end face of the negative electrode 2 facing the positive electrode current collector plate 6, i.e., the dimension of (D3-C3), were set to 100 μm.

Except for the above, in the same manner as in Comparative Example 1, a battery (5) was produced.

The batteries (1) to (5) produced in the above manner were evaluated as follows.

### [Evaluation]

### (1) Measurement of Battery Capacity

Each battery was charged at a constant current of 1 A until the battery voltage reached 4.2 V, and then charged at a constant voltage of 4.2 V until the charge current value decreased to 0.2 A. Thereafter, each battery was discharged at 1 A until the battery voltage reached 2.5 V, to determine the discharge capacity (battery capacity). The number of tested batteries of each kind was 30, and the battery capacity was defined as the average value of the discharge capacities of the 30 batteries. When a battery had a capacity of 900 mAh or more, the battery was judged to have a high capacity (high energy density).

### (2) Measurement of OCV Defect Rate

Each battery was charged at a constant current of 1 A for 4 hours. After the passage of 10 minutes from the charge, the open-circuit voltage (V1) of the battery was measured.

Also, each battery was charged under the same conditions as described above, and then stored at 45° C. for 48 hours. The open-circuit voltage (V2) of the stored battery was measured. Then, (V1-V2) (the difference in open-circuit voltage between before and after the storage) was obtained.

When a battery had a (V1-V2) value of 100 mV or more, the battery was judged to be defective.

The number of tested batteries of each kind was 30, and the ratio (OCV defect rate) of batteries judged to be defective to the 30 batteries was obtained.

Table 1 shows the evaluation results.

TABLE 1

| | | | Distance between | Distance between | | |
|---|---|---|---|---|---|---|
| | | | negative current | positive current | | |
| | | | collector plate and | collector plate and | | |
| | | | end of separator on | end of separator on | | OCV |
| | | | negative current | positive current | Battery | defect |
| | | | collector plate | collector plate | capacity | rate |
| | Battery | Separator | side (mm) | side (mm) | (mAh) | (%) |
| EX 1 | (1) | Porous | 1 | 1 | 1000 | 0 |
| | | insulating | | | | |
| | | layer | | | | |
| EX 2 | (2) | Porous | 3 | 3 | 915 | 0 |
| | | insulating | | | | |
| | | layer | | | | |
| COM | (3) | Polyethylene | 1 | 1 | 1000 | 100 |
| EX 1 | | film | | | | |
| COM | (4) | Polyethylene | 3 | 3 | 900 | 33 |
| EX 2 | | film | | | | |
| COM | (5) | Porous | 1 | 1 | 840 | 7 |
| EX 3 | | insulating | | | | |
| | | layer and | | | | |
| | | polyethylene | | | | |
| | | film | | | | |

The batteries (1) and (2) of Examples 1 and 2 of the invention had high capacities and an OCV defect rate of 0%. In the batteries (1) and (2), only the heat-resistant porous insulating layer is disposed between the positive electrode and the negative electrode. Thus, even when the temperature of the joint between the current collector plate and the electrode core member exposed part becomes high due to TIG welding, the porous insulating layer is not affected by heat due to welding. Therefore, the positive electrode was successfully insulated by the porous insulating layer from the negative electrode.

Also, the batteries (1) and (2) provided high energy density, since the end of the porous insulating layer can be disposed closer to the electrode current collector than is conventionally disposed and the electrode mixture layers could be made larger. It was possible to provide highly reliable secondary batteries having a high power tabless structure without lowering the energy density.

Contrary to this, in the case of the battery (3) of Comparative Example 1, all the batteries became defective in OCV. The reason is probably as follows. In the battery (3), the conventionally used polyethylene film was used as the separator. Thus, upon TIG welding, the temperature of the joint became high and the separator shrunk due to the impact of heat generated by the welding, so that the positive electrode came into contact with the negative electrode, thereby resulting in an internal short-circuit.

In the battery (4) of Comparative Example 2, the polyethylene film was used as the separator in the same manner as in the battery (3), but the OCV defect rate was lower than that of the battery (3). This is probably because the distance between the welded part of the electrode current collector plate and the end of the separator on the electrode current collector plate side was large, and thus the impact of heat on the separator due to the welding of the electrode core member exposed part to the electrode current collector plate was reduced. However, since the electrode core member exposed part was enlarged, the electrode mixture layer became small, so that the capacity of the battery (4) decreased. In the case of using the conventional polyethylene film as the separator, in order to make the OCV defect rate 0%, it was necessary to make the electrode core member exposed part larger than that of the battery (4), So that the width of the positive electrode core member exposed part was 14 mm and the width of the negative electrode core member exposed part was 10 mm. In this case, the battery capacity was 670 mAh, which was a large decrease.

In the battery (5) of Comparative Example 3, since the porous insulating layer and the polyethylene film were used in combination, the length of the electrodes inserted into the battery case became less than that of the battery (3), so that the battery capacity decreased. Also, in the specifications of the battery (5), some of the batteries were found to be defective in OCV. This is probably because the polyethylene film shrunk due to the impact of heat generated by the welding of the electrode core member exposed part to the current collector plate, and the shrinkage caused a part of the porous insulating layer to become separated from the polyethylene film.

### EXAMPLE 4

A non-aqueous electrolyte secondary battery (6) was produced in the same manner as in Example 2, except that laser welding was used instead of TIG welding as the method of welding the electrode core member exposed part to the electrode current collector plate in the battery production process. The OCV defect rate of the battery (6) was obtained in the same manner as described above.

The OCV defect rate of the battery (6) was 20%, so the OCV defect rate was higher than that of the battery (2).

The batteries (6) judged to be defective in OCV were disassembled for examination. As a result, the current collector plates were found to have a hole. Laser welding involves concentrated heat compared with TIG welding. Hence, even when the heat-resistant porous insulating layer was used, a part of the current collector plate melted to form a hole, thereby resulting in an OCV defect.

This indicates that the welding of the electrode core member exposed part to the current collector plate is preferably TIG welding.

In the foregoing Examples, cylindrical non-aqueous electrolyte secondary batteries were produced, but secondary batteries such as prismatic non-aqueous electrolyte secondary batteries, nickel-metal hydride storage batteries, and nickel-cadmium storage batteries can also produce essentially the same effects.

The secondary battery of the invention has high reliability, high power, and high energy density, and can be used advantageously in power tools and in applications requiring high power and long-term durability such as power storage and electric vehicles.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A secondary battery comprising:
an electrode assembly comprising a first electrode and a second electrode which are wound or laminated with only a heat-resistant porous insulating layer interposed between the first electrode and the second electrode; and
a first current collector plate electrically connected to the first electrode,
wherein the first electrode includes a first electrode core member and a first electrode mixture layer formed on the first electrode core member,
the second electrode includes a second electrode core member and a second electrode mixture layer formed on the second electrode core member,
an end of the first electrode protrudes from an end of the second electrode and an end of the porous insulating layer at an end face of the electrode assembly,
the protruding end of the first electrode has a part where the first electrode core member is exposed,
the part where the first electrode core member is exposed is welded to the first current collector plate,
the end of the porous insulating layer protrudes from an end of the first electrode mixture layer and an end of the second electrode mixture layer, and
the distance between the first current collector plate and the end of the porous insulating layer on the first current collector plate side is 3 mm or less.

2. The secondary battery in accordance with claim 1, further comprising a second current collector plate electrically connected to the second electrode,
wherein an end of the second electrode protrudes from an end of the first electrode and an end of the porous insulating layer at another end face of the electrode assembly,
the protruding end of the second electrode has a part where the second electrode core member is exposed, and
the part where the second electrode core member is exposed is welded to the second current collector plate.

3. The secondary battery in accordance with claim 2, wherein the distance between the second current collector plate and the end of the porous insulating layer on the second current collector plate side is 3 mm or less.

4. The secondary battery in accordance with claim 1, wherein the porous insulating layer includes ceramic particles.

5. The secondary battery in accordance with claim 1, wherein the porous insulating layer comprises ceramic particles and a binder.

6. The secondary battery in accordance with claim 1, wherein the porous insulating layer is formed so as to cover at least one of the first electrode mixture layer and the second electrode mixture layer.

7. The secondary battery in accordance with claim 1, wherein the secondary battery is a non-aqueous electrolyte secondary battery.

8. The secondary battery in accordance with claim 1, wherein the part where the first electrode core member is exposed is connected to the first current collector plate by arc welding.

9. The secondary battery in accordance with claim 2, where the part where the second electrode core member is exposed is connected to the second current collector plate by arc welding.
